(19) United States
(12) Patent Application Publication
(10) Pub. No.: US 2015/0349447 A1
(43) Pub. Date: Dec. 3, 2015

(54) CONTACT STRIP STRUCTURE

(71) Applicant: SPEED TECH CORP., TAOYUAN CITY (TW)

(72) Inventors: Hua-Chun CHANG, TAOYUAN CITY (TW); Chien-Yu HSU, TAOYUAN CITY (TW)

(21) Appl. No.: 14/698,830

(22) Filed: Apr. 28, 2015

(30) Foreign Application Priority Data
May 30, 2014 (TW) 103209720

(51) Int. Cl. H01R 13/02; H01R 13/405

(52) U.S. Cl. CPC H01R 13/02; H01R 13/405

(57) ABSTRACT

A contact strip structure includes a fixing portion, a plurality of first terminals, a plurality of second terminals and a strip. The first terminals and the second terminals are fixed to the fixing portion. Two ends of the strip respectively extend in parallel from outsides of the first terminals and the second terminals for a distance, and then vertically extend and mutually contact with the first terminals and the second terminals to form at least one bridge. The first terminals and the second terminals are synchronously fixed to the fixing portion by insert molding.

### RELATED APPLICATIONS

This application claims priority to Taiwan Application Number 103209720, filed May 30, 2014, which is herein incorporated by reference.

### BACKGROUND

1. Technical Field

The present disclosure relates to contact strip structures. More particularly, the present disclosure relates to contact strip structures which allow insert molding to be simultaneously carried out for two rows of terminals.

2. Description of Related Art

Electrical connectors such as universal serial bus (USB) connectors and high definition multimedia interface (HDMI) connectors are largely used in the field of signal transmission. The method to reduce the manufacturing cost of the electrical connectors is an important factor to gain a competitive position in the market. A key component of an electrical connector is a terminal module, which generally includes an insulating main body and a plurality of terminals partially supported in the insulating main body. Most of the terminal modules of the existing electrical connectors include two groups of terminals. Moreover, the two groups of terminals generally come from different terminal strips. Therefore, in the manufacturing procedure of the terminal modules, two groups of terminals are required to be processed. Afterwards, plastic is used to coat and fix one of the terminal groups through the manufacturing process of injection molding. A terminal hole is reserved in the plastic in the manufacturing process of injection molding, such that the terminals of the second group are respectively inserted into the reserved terminal hole after the manufacturing process of injection molding is completed. Consequently, the terminal module formed and other components are assembled together to the casing of the electrical connector, in order to form the electrical connector.

For the traditional module and its manufacturing methods as described above, there exist some disadvantages such as too many steps in the manufacturing process and much waste of terminal strips. As a result, the industry provides a strip structure which allows insert molding to be simultaneously carried out for two rows of terminals. As shown in FIG. 9, the Taiwan patent M477619 provides a terminal module and its manufacturing method. The terminal module A100 includes an insulating main body A10, a first terminal group A21 and a second terminal group A22. The first terminal group A21 and the second terminal group A22 are alternately arranged and partially supported on the insulating main body A10 by the method of integrated injection molding. Each of terminals in the first terminal group A21 and the second terminal group A22 includes a first end (not shown in FIG. 9). The first end (not shown in FIG. 9) is configured to connect with the same terminal strip A30. On the other hand, two groups of terminals A21, A22 are fabricated from the same terminal strip A30 by mechanical machining. Afterwards, plastic is used to coat and fix the two groups of terminals A21, A22 by the process of injection molding.

Since the first terminal group A21 and the second terminal group A22 are extended from the terminal strip A30 towards the same direction, there is some space between the terminal strip A30 and both of the first terminal group A21 and the second terminal group A22. Thus, the first terminal group A21 and the second terminal group A22 are not directly protected by the terminal strip A30. This means the first terminal group A21 and the second terminal group A22 are not easy to be kept stable during processing, and are easy to be bent, broken or damaged by any expected external factors during the manufacturing process. Thus, the overall yield cannot be effectively increased and is left as an issue to be solved in the industry.

### SUMMARY

A technical aspect of the present disclosure provides a contact strip structure. The contact strip structure belongs to a USB connector of Type C. It utilizes a strip with two ends extending in parallel for a distance, then vertically extending and mutually connecting with a plurality of terminals to form at least one bridge. The distance between the bridge and a fixing portion is shorter than the distance between the strip and the bridge. The majority of the terminals are under protection as surrounded by the strip and the bridge. The overall stability of the terminals is increased. When the terminals are simultaneously fixed to the fixing portion by insert molding, the occurrence of positional shifting of each of the terminals is reduced. In addition, the structure of the product design of the strip is relatively simple, effectively increasing the yield rate of mass production in the manufacture of the final products.

According to an embodiment of the present disclosure, a contact strip structure includes a strip, a plurality of first terminals, a plurality of second terminals and a fixing portion. The first terminals and the second terminals are regularly arranged in the same spacing. The first terminals and the second terminals are fixed to the fixing portion. Two ends of the strip respectively extend in parallel from outsides of the first terminals and the second terminals for a distance, and then vertically extend and mutually contact with the first terminals and the second terminals to form at least one bridge. The bridge can be arranged in a straight line pattern. The first terminals and the second terminals are synchronously fixed to the fixing portion by insert molding.

According to an embodiment of the present disclosure, the strip has a through hole. The through hole is a positioning design configured to fix the strip. When the strip is driven during the operation of the transmission belt in the manufacturing process, the through hole can be detected if the strip is in position. The through hole is also used to further fix the strip for the subsequent formation by the bending of the first terminals and the second terminals. Each of the first terminals has a first contact portion, a first connecting portion, and a first holding portion, the first connecting portion is formed by a vertical extension from the first contact portion, and the first holding portion is formed by an extension from an end of the first connecting portion. Each of the second terminals has a second contact portion, a second connecting portion, and a second holding portion, the second connecting portion is formed by a vertical extension from the second contact portion, and the second holding potion is formed by an extension from an end of the second connecting portion.

According to an embodiment of the present disclosure, the length of each of the first contact portions is longer than the length of each of the second contact portions. Each of the first connecting portions and each of the second connecting portions are arranged in tandem. This means each of the first connecting portions and each of the second connecting portions are arranged in two rows in an order of front and rear. Each of the first connecting portions and each of the second connecting portions can carry out the method of insert molding with the fixing portion, not leading to the shifting of the pre-set position of each of the first connecting portions and each of the second connecting portions. The first contact portions, the second contact portions, the strip, and the bridge are on the same plane, facilitating the procedure of cutting of the strip and the bridge, and thus implementing a separation from the first terminals and the second terminals.

According to an embodiment of the present disclosure, each of the first holding portions and each of the second holding portions comply with a Surface Mount Technology (SMT) or a pattern of through-holes, in order to meet the requirements of the circuit design, and thus adjusting the adoption type of each of the first holding portions and each of the second holding portions. Moreover, the distance between the bridge and the fixing portion is shorter than the distance between the strip and the bridge, which can indirectly reinforce the stability of each of the first terminals and each of the second terminals during the manufacturing process.

The other applications of the present disclosure become obvious by the disclosure of this specification. However, the disclosure of this specification is by the surrounding of the strip and at least one bridge to the majority of the terminals, so as to increase the overall stability of the terminals as a final product. On the other hand, the design structure of the strip is simple. Thus, the production process can be simplified and the manufacturing cost can be reduced. It will be apparent to the person having ordinary skill in the art that various modifications and variations can be made to the structure of the present disclosure without departing from the scope or spirit of the present disclosure.

### BRIEF DESCRIPTION OF THE DRAWINGS

The disclosure can be more fully understood by reading the following detailed description of the embodiments, with reference made to the accompanying drawings as follows:

FIG. 1 is a perspective view of a contact strip structure in the first view angle according to the first embodiment of the present disclosure;

FIG. 2 is a perspective view of the contact strip structure of FIG. 1 in the second view angle;

FIG. 3 is an exploded view of the contact strip structure of FIG. 1 in the first view angle;

FIG. 4 is an exploded view of the contact strip structure of FIG. 1 in the second view angle;

FIG. 5 is a perspective view of a contact strip structure in the first view angle according to the second embodiment of the present disclosure;

FIG. 6 is a perspective view of the contact strip structure of FIG. 5 in the second view angle;

FIG. 7 is an exploded view of the contact strip structure of FIG. 5 in the first view angle;

FIG. 8 is an exploded view of the contact strip structure of FIG. 5 in the second view angle; and

FIG. 9 is perspective view of the terminal module disclosed in Taiwan patent M447619.

### DETAILED DESCRIPTION

Drawings will be used below to disclose a plurality of embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

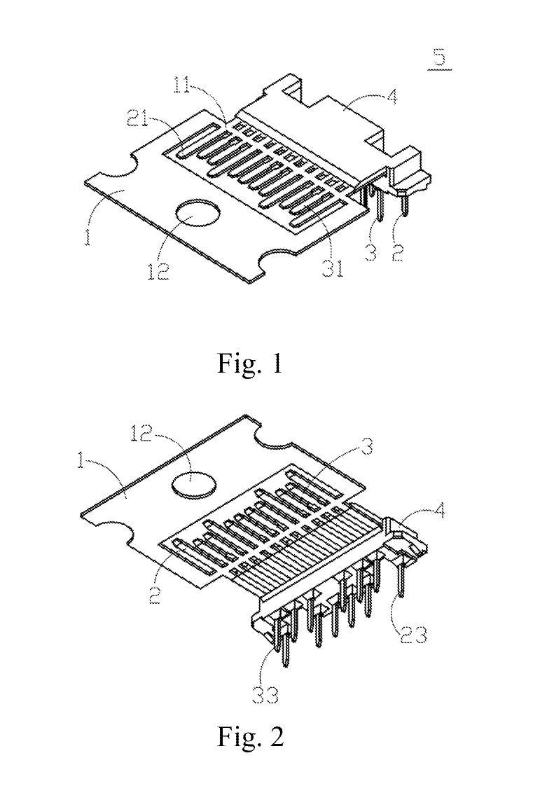

As shown in FIGS. 1-2, the present disclosure provides a contact strip structure 5. The contact strip structure 5 includes a strip 1, a plurality of first terminals 2, a plurality of second terminals 3 and a fixing portion 4. The first terminals 2 and the second terminals 3 are regularly arranged in the same spacing. Each of the second terminals 2 is interspersed between each of the first terminals 2 with the quantity being unset. The first terminals 2 and the second terminals 3 are fixed to the fixing portion 4. Two ends of the strip 1 respectively extend in parallel from outsides of the first terminals 2 and the second terminals 3 for a distance, and then vertically extend face to face and mutually contact with the first terminals 2 and the second terminals 3 to form a first bridge 11. The first bridge 11 can be arranged in a straight line pattern. The first bridge 11 can also be arranged in a pattern of a curve. The first bridge 11 is arranged in a straight line pattern in FIGS. 1-2 in the present disclosure. The first terminals 2 and the second terminals 3 are synchronously fixed to the fixing portion 4 by insert molding.

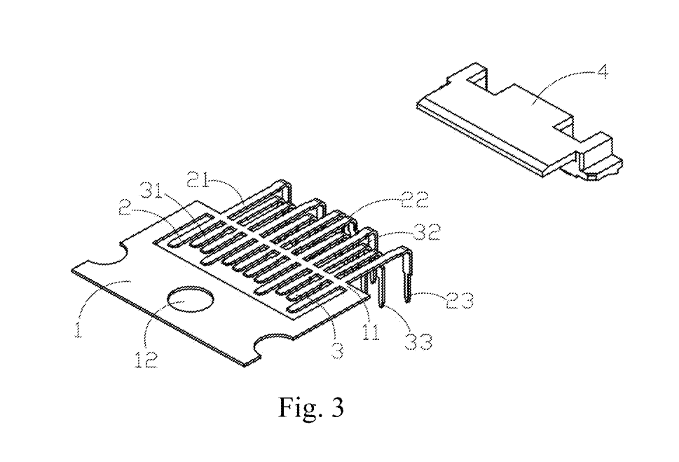

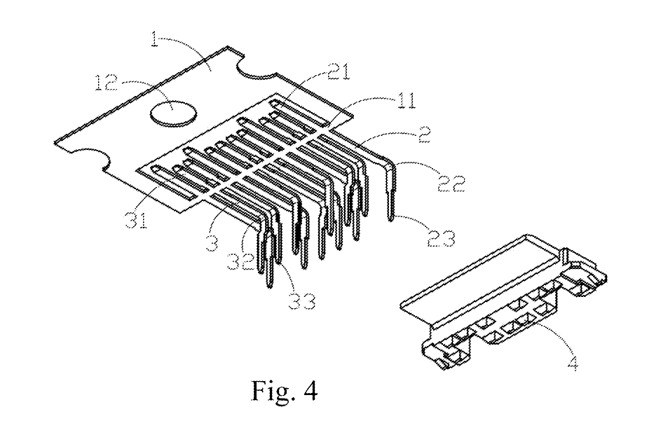

As shown in FIGS. 3-4, in the first embodiment of the present disclosure, the strip 1 has a through hole 12 in the center. The through hole 12 is a positioning design configured to assist to fix the strip 1. When the strip 1 is driven during the operation of the transmission belt (not shown in FIGS. 3-4) in the manufacturing process, the through hole 12 can be detected by visual inspection using a detection pin (not shown in FIGS. 3-4) if the strip 1 is in position. The through hole is used to further fix the strip 1 for the subsequent formation by the bending of the first terminals 2 and the second terminals 3. Each of the first terminals 2 has a first contact portion 21, a first connecting portion 22, and a first holding portion 23, the first connecting portion 22 is formed by a vertical extension from the first contact portion 21, and the first holding portion 23 is formed by an extension from an end of the first connecting portion 22. Each of the second terminals 3 has a second contact portion 31, a second connecting portion 32, and a second holding portion 33, the second connecting portion 32 is formed by a vertical extension from the second contact portion 31, and the second holding potion 33 is formed by an extension from an end of the second connecting portion 32. Each of the first contact portions 21 and each of the second contact portions 31 are used to electrically connect with a docking connect (not shown in the Figs.). Each of the first connecting portions 22 and each of the second connecting portions 32 are fixed on the fixing portion 4. Each of the first holding portions 23 and each of the second holding portions 33 are electrically connected with a circuit board (not shown in the Figs.).

As shown in FIGS. 3-4, in the first embodiment of the present disclosure, the length of each of the first contact portions 21 is longer than the length of each of the second contact portions 31. Moreover, each of the first connecting portions 22 and each of the second connecting portions 32 are arranged in tandem. This means each of the first connecting portions 22 and each of the second connecting portions 32 are arranged in two rows in an order of front and rear. Each of the first connecting portions 22 and each of the second connecting portions 32 can carry out the method of insert molding synchronously with the fixing portion 4. Due to the protection of the strip 1 and the first bridge 11, the relative stability of the structure of each of the first connecting portions 22 and each of the second connecting portions 32 is reinforced, not leading to the shifting of the pre-set position of each of the first connecting portions 22 and each of the second connecting portions 32. The first contact portions 21, the second contact portions 31, the strip 1, and the first bridge 11 are on the same plane, facilitating the procedure of cutting of the strip 1 and the first bridge 11, and thus the separation of the first strip 1 and the bridge 11 from the first terminals 2 and the second terminals 3.

As shown in FIGS. 1 and 4, in the first embodiment of the present disclosure, each of the first holding portions 23 and each of the second holding portions 33 comply with a Surface Mount Technology (SMT) or a pattern of through-holes, in order to meet the requirements of the circuit design, and thus adjusting the adoption type of each of the first holding portions 23 and each of the second holding portions 33. The pattern of through-holes is adopted here. Moreover, the distance between the first bridge 11 and the fixing portion 4 is shorter than the distance between the strip 1 and the first bridge 11. Since the first bridge 11 is closer to the fixing portion 4, the stability of each of the first terminals 2 and each of the second terminals 3 during the manufacturing process can be indirectly reinforced.

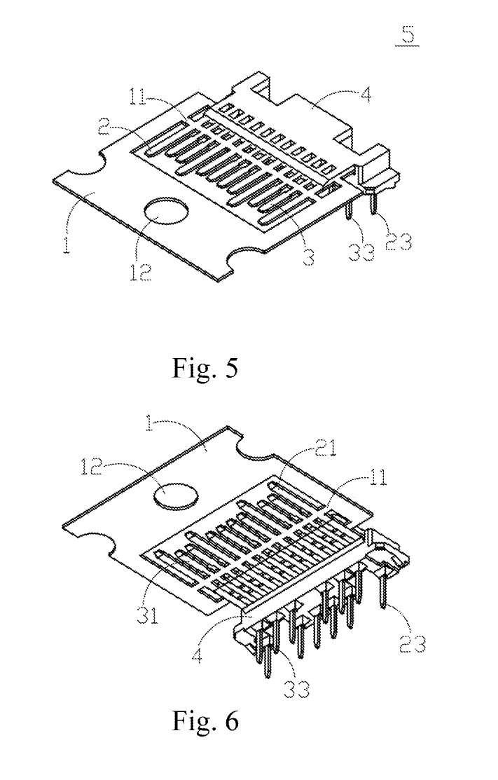

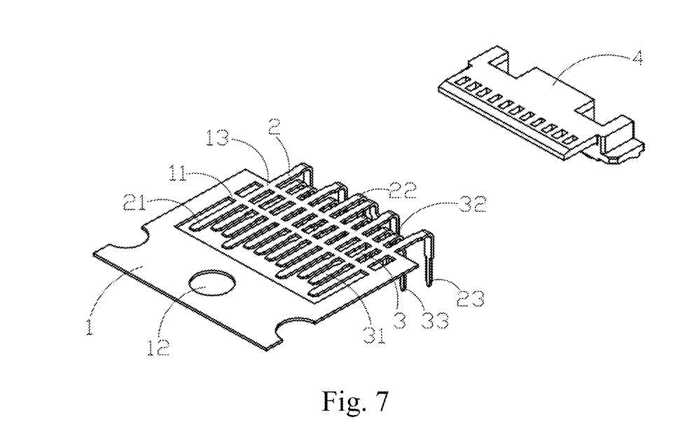

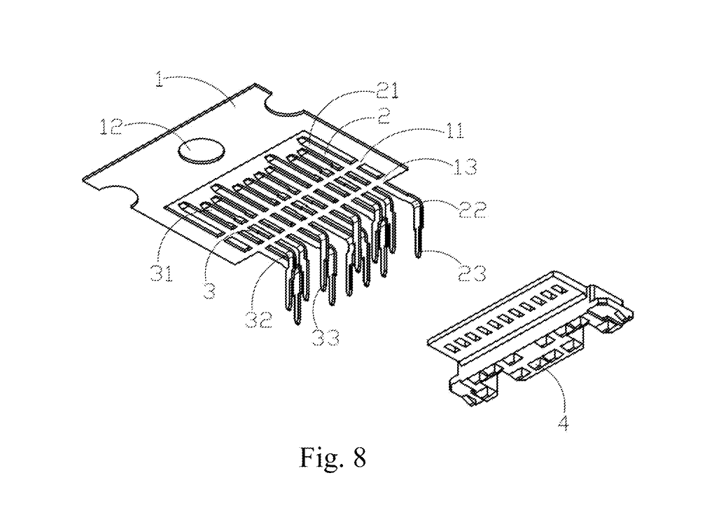

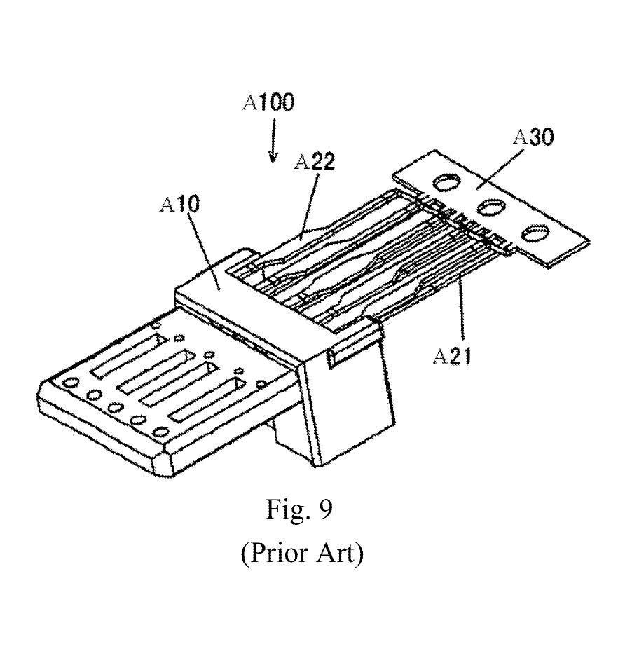

As shown in FIGS. 5-8, in the second embodiment of the present disclosure, as at a small spacing away from the first bridge 11, the strip 1 extends and mutually contacts with the first terminals 2 and the second terminals 3 to form a second bridge 13. The second bridge 13 and the first bridge 11 are arranged side by side, configured to increase the strength of the overall structure of each of the first terminals 2 and each of the second terminals 3.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A contact strip structure, comprising:
a fixing portion;
a plurality of first terminals fixed to the fixing portion;
a plurality of second terminals fixed to the fixing portion; and
a strip, two ends of the strip respectively extending in parallel from outsides of the first terminals and the second terminals for a distance, and then vertically extending and mutually contacting with the first terminals and the second terminals to form at least one bridge, the first terminals and the second terminals being synchronously fixed to the fixing portion by insert molding.

2. The contact strip structure of claim 1, wherein the strip has a through hole, and the through hole is a positioning design configured to fix the strip.

3. The contact strip structure of claim 1, wherein each of the first terminals has a first contact portion, a first connecting portion, and a first holding portion, the first connecting portion is formed by a vertical extension from the first contact portion, and the first holding portion is formed by an extension from an end of the first connecting portion.

4. The contact strip structure of claim 3, wherein the first contact portions, the strip, and the bridge are on the same plane.

5. The contact strip structure of claim 3, wherein each of the first holding portions complies with a surface mount technology or a pattern of through-holes.

6. The contact strip structure of claim 1, wherein each of the second terminals has a second contact portion, a second connecting portion, and a second holding portion, the second connecting portion is formed by a vertical extension from the second contact portion, and the second holding potion is formed by an extension from an end of the second connecting portion.

7. The contact strip structure of claim 6, wherein the second contact portions, the strip, and the bridge are on the same plane.

8. The contact strip structure of claim 6, wherein each of the second holding portions complies with a surface mount technology or a pattern of through-holes.
